(19) United States
(12) Patent Application Publication
(10) Pub. No.: US 2004/0150793 A1
(43) Pub. Date: Aug. 5, 2004

(54) Illumination system for a projector

(76) Inventors: Sean Chang, Taoyuan Hsien (TW); Albert Lin, Taoyuan Hsien (TW)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/635,456

(22) Filed: Aug. 7, 2003

(30) Foreign Application Priority Data
Jan. 30, 2003 (TW) 92102340

(51) Int. Cl. G03B 21/14

(52) U.S. Cl. 353/20

(57) ABSTRACT

An illumination system has light source, an ellipsoidal reflector, an auxiliary reflector, an enclosure, and light tunnel. The combination of the ellipsoidal reflector and the auxiliary reflector is used to improve the light collecting efficiency. A reflective film is coated on the inner surface of the ellipsoidal reflector to reflect visible light but infrared and ultraviolet, and an absorptive film is coated on the inner surface of the enclosure to absorb infrared and ultraviolet then exhaust heat by the enclosure.

### BACKGROUND OF THE INVENTION

1. Field of Invention

The present invention relates to a projector. More particularly, the present invention relates to an illumination system for a projector.

2. Description of Related Art

Since optical projectors have been developed they have been applied in many fields. They serve an expanded range of purposes, from consumption products to high technology, such as using projective systems for projecting enlarged images, or incorporating a projection screen or television for projecting and displaying real-time images with presentations during conferences. However, projector applications broaden, demands on contrast and brightness of projectors are also higher. An Illumination system of a projector mostly determines the contrast and brightness thereof.

FIG. 1 is a schematic view of a conventional illumination system of a projector. As shown in FIG. 1, in an existing framework of the illumination system, light source 102 is configured at a first focus 122 of an ellipsoidal reflector 104. An inlet of light tunnel 108 is configured at a second focus 124 of the ellipsoidal reflector 104. By the optical reflection character of the ellipsoid, the ellipsoidal reflector 104 focuses light emitted from the light source 102 at the first focus 122 on the inlet of the light tunnel 108 at the second focus 124. At this moment, the light first passes through a color wheel 106, and then is transmitted uniformly by the light tunnel 108 to a digital micro-mirror device (DMD) chip (not illustrated in FIG. 1).

Light collecting efficiency (a ratio of the light outputted by the light tunnel 108 to the light emitted by the light source 102) in the framework as illustrated in FIG. 1 is only 75%. The reason is that the light emitted from light source 102 has light path 112 in addition to light path 110. Light propagated along the light path 112 can't enter the light tunnel 108 because it is not reflected by the ellipsoidal reflector 104, and light intensity is thus wasted.

If, however, two wing sections of the ellipsoidal reflector 104 are extended to be able to reflect the light propagated along the light path 112, the angle of the light entering the light tunnel 108 is too large and then an angle of the light outputted from the light tunnel to the DMD chip is also too large. The too-large angle of the light emitted into the DMD chip is beyond a receiving angle of the DMD chip, thus making the micro mirrors of the DMD chip unable to be switched successfully to optical states between on/off. When the micro mirrors are switched to the “off” state, the light of the too-large angle is still emitted to a projection lens, thus making the screen insufficiently dark and decreasing the contrast and brightness of a projector.

Moreover, another design problem of the projector is the heat dissipation of the projector. If the two wing sections of the ellipsoidal reflector 104 are extended, heat energy inside the ellipsoidal reflector 104 dissipates with greater difficulty. Therefore, heat dissipation efficiency, lifetime and luminescent efficiency of the light source 102 are all lowered.

### SUMMARY OF THE INVENTION

It is therefore an objective of the present invention to provide an illumination system for a projector that satisfies the need to improve the problems of bad luminescent efficiency and poor heat dissipation of the illumination system in a projector.

In accordance with the foregoing and other objectives of the present invention, an illumination system for a projector is described. The invention provides an auxiliary reflector installed at a position that cannot be reflected by the ellipsoidal reflector. A shape of the auxiliary reflector is a portion of a sphere or a portion of an aspherical curve, for precisely reflecting the light back to the light source and forward to the ellipsoidal reflector.

For heat dissipation, a reflective film is coated on reflecting surfaces of the ellipsoidal reflector and the auxiliary reflector. The reflective film only reflects light needed by the projector while transmitting other unnecessary light so that energy of the light does not accumulate inside the ellipsoidal and auxiliary reflectors.

Furthermore, the invention provides an enclosure configured outside the ellipsoidal reflector and the auxiliary reflector. An absorbent film is coated on an inner surface of the enclosure to absorb light transmitted through the ellipsoidal reflector and the auxiliary reflector, and then to convert the same into heat energy to be dissipated outside.

In one preferred embodiment of the present inventions, the shape of the auxiliary reflector is a portion of a sphere or a portion of an aspherical curve, and has an opening. The enclosure also has an enclosure opening. The two openings are configured on an imagined straight line formed by the first focus and the second focus of the ellipsoidal reflector.

Forms and dimensions of the openings are determined by an angle and a power of the light emitted into the light tunnel. The necessary light is visible light, and the unnecessary light is infrared and ultraviolet. A material of the reflective film includes a cold mirror material.

In conclusion, the framework of the invention enhances the light collecting efficiency by more than 85% with the use of an additional auxiliary reflector, and a divergent angle of the light emitted into the light tunnel is less than that of the conventional design. The light collecting efficiency has a critical effect of the brightness of the projector, and the divergent angle of light is relevant to the contrast of the projector. The invention therefore facilitates manufacture of high luminance and high contrast projectors.

Since half the light in the illumination system of the invention is reflected back to the light source, if the reflected light includes infrared light, the temperature of the light source rises and shortens the projector's lifetime. The invention uses special designs for the reflective film of the reflectors, and adds a corresponding absorbent film on the enclosure outside the reflectors to resolve this problem.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a schematic view of a conventional illumination system of projector;

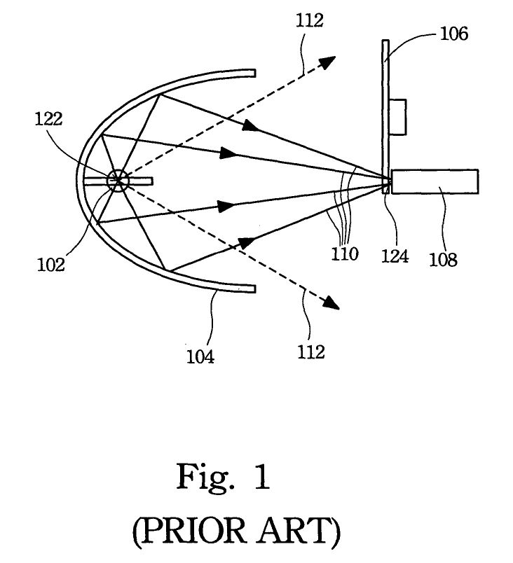

FIG. 2 is a schematic view according to one preferred embodiment of this invention;

FIG. 3 is a schematic view according to another preferred embodiment of this invention; and

FIG. 4 is a schematic view of light propagated of the preferred embodiment in FIG. 3.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention provides an illumination system for a projector to improve the problems of poor luminescent efficiency and poor heat dissipation of the illumination system in a projector.

The invention provides an auxiliary reflector placed in a position where the ellipsoidal reflector cannot reflect. The auxiliary reflector reflects the light emitted from the light source back to the light source, so the light formerly not reflected by the ellipsoidal reflector is reflected by the auxiliary reflector and passes through the light source, and then is finally reflected by the ellipsoidal reflector to enter the light tunnel.

Moreover, the invention coats a reflective film on the ellipsoidal and auxiliary reflectors to resolve the poor heat dissipation problem. The reflective film only reflects light needed by the projector, and transmits other unnecessary light the reflective film and radiates the same outside, so that energy of light inside the ellipsoidal and auxiliary reflectors is not accumulated.

Furthermore, the invention further provides an enclosure made of heat-dissipating materials and installed outside the ellipsoidal and auxiliary reflectors. The enclosure is coated with an absorbent film on an inner surface thereof to absorb the unnecessary light, and the unnecessary light is converted to heat energy and dissipated outside by thermal conduction of the heat-dissipation materials.

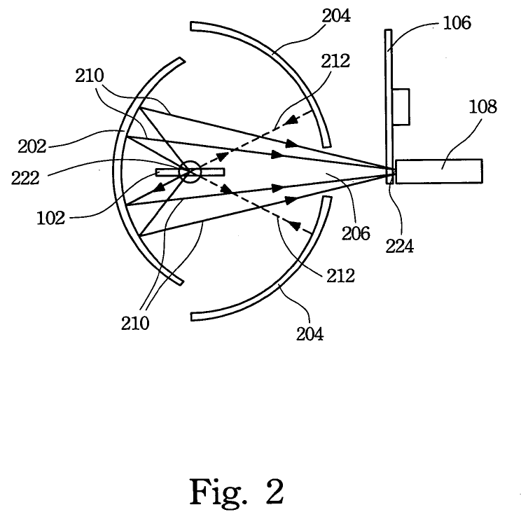

FIG. 2 is a schematic view of one preferred embodiment of the invention. As shown in FIG. 2, the invention provides an auxiliary reflector 204 installed near two sides of an ellipsoidal reflector 202 where the ellipsoidal reflector 202 cannot reflect. Light source 102 is an arc lamp, configured at a first focus 222 of the ellipsoidal reflector 202.

Light emitted from the light source 102 has two main light paths of propagation. One light path 210 is light emitted from the light source 102 and reflected by the ellipsoidal reflector 202 to light tunnel 108 at a second focus 224 of the ellipsoidal reflector 202. The light passes through a color wheel 106 before entering the light tunnel 108. Another light path 212 is that of light emitted from the light source 102, first reflected by the auxiliary reflector 204 back to the light source 102, then reflected by the ellipsoidal reflector 202 to the light tunnel 108 at the second focus of the ellipsoidal reflector 202, and then also passed through the color wheel 106 before entering the light tunnel 108.

The auxiliary reflector 204 has an opening 206, and light propagated along the light paths 210 and 212 can pass through the opening 206 to enter the light tunnel 108. A dimension and a form of the opening 206 are determined by an angle and a power of the light emitted into the light tunnel 108. In this embodiment, a shape of the auxiliary reflector 204 is a portion of a sphere or a portion of an aspherical curve, for precisely reflecting the light back to the light source 102 and forward the ellipsoidal reflector 202. A maximum shape of the auxiliary reflector 204 is a hemisphere or a half portion of the aspherical curve; otherwise the light reflected inside might be reflected to and from itself. A dimension of the ellipsoidal reflector 202 is also determined by an angle of the light emitted into the light tunnel 108, and the auxiliary reflector 204 must be larger than the ellipsoidal reflector 202, so that light that not reflected by the ellipsoidal reflector 202 can be reflected without loss.

Moreover, in this embodiment, materials of the ellipsoidal reflector 202 and the auxiliary reflector 204 are transparent materials that at least are able to transmit the unnecessary light. A reflective film is coated on reflecting surfaces of the ellipsoidal reflector 202 and the auxiliary reflector 204. The reflective film only reflects light needed by the projector while transmitting other unnecessary light. The reflective film of the preferred embodiment is a cold mirror film whose transmittance of visible light is less than 5% and transmittance of infrared is more than 80%. The visible light needed by the projector therefore is reflected and other infrared or ultraviolet, which generates heat energy, is transmitted outside by the ellipsoidal reflector 202 and the auxiliary reflector 204.

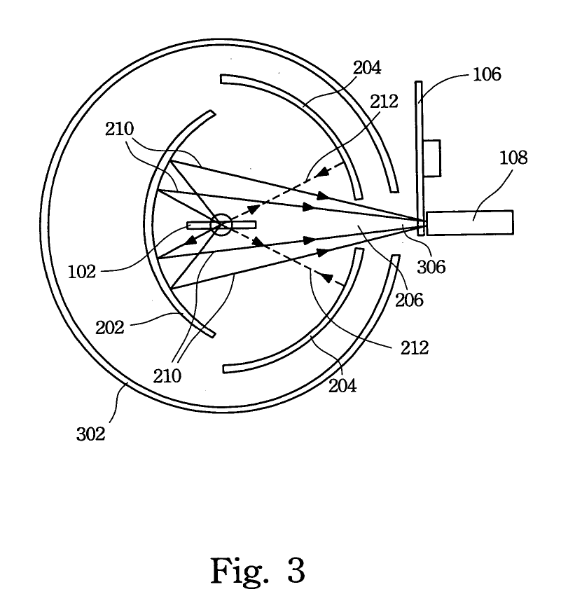

FIG. 3 is a schematic view of another embodiment of the invention. As shown in FIG. 3, a framework of FIG. 3 is similar to that of FIG. 2, further including an enclosure 302 configured outside the ellipsoidal reflector 202 and the auxiliary reflector 204. A shape of the enclosure 302 depends on a configuration inside the projector, and is, for example, a sphere in FIG. 3. The enclosure 302 also includes an enclosure opening 306 for light passing through thereby to enter the light tunnel 108.

A dimension and a form of the opening 306 are determined by an angle and a power of the light emitted into the light tunnel 108. The invention further provides an absorbent film on an inner surface of the enclosure 202 to absorb the light transmitted through the ellipsoidal reflector 202 and the auxiliary reflector 204. In this preferred embodiment, a material of the enclosure 302 is a heat-dissipating material, such as metal, and the absorbent film is used to absorb infrared and ultraviolet light.

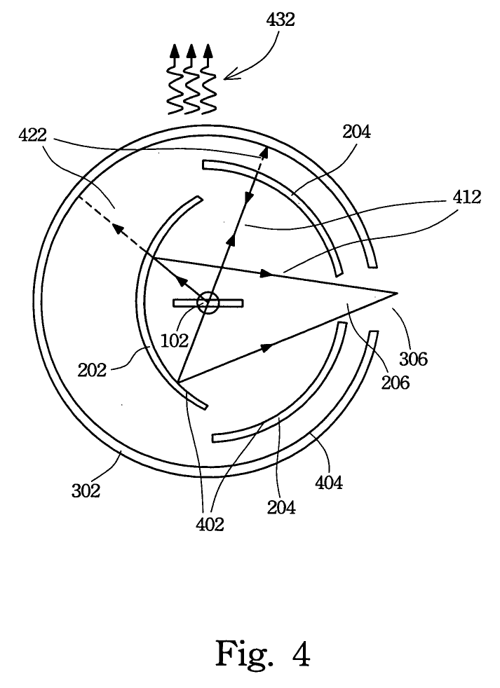

FIG. 4 is a schematic view of light propagated of the preferred embodiment in FIG. 3. As shown in FIG. 4, reflective films 402 are coated on inner surfaces of the ellipsoidal reflector 202 and the auxiliary reflector 204, and an absorbent film is coated on a inner surface of the enclosure 302. After light is emitted from the light source 102, the visible light is reflected by the reflective films 402 of the ellipsoidal film 202 and the auxiliary film 204, and along light path 412 (a solid line path in FIG. 4) passing through the opening 206 and the enclosure opening 306; other light, such as infrared and ultraviolet, is transmitted through the ellipsoidal reflector 202 and the auxiliary reflector 204, and along light path 422 (indicated by a dashed line in FIG. 4) is absorbed by the absorbent film 404 of the enclosure 302, converted to heat energy 432 and dissipated outside.

In conclusion, the framework of the invention enhances the light collecting efficiency by more than 85% with the use of an additional auxiliary reflector, and a divergent angle of the light emitted into the light tunnel is less than that of the conventional design. The light collecting efficiency has a critical effect on the brightness of the projector, and the divergent angle of light is relevant to the contrast of the projector. The invention therefore facilitates to manufacture of high luminance and high contrast projectors.

Since half of the light in the illumination system is reflected back to the light source in the invention, if the reflected light includes the infrared, the temperature of the light source is raised and lifetime thereof lowered. The invention has special designs for the reflective film of the reflectors, and adds a corresponding absorbent film on the enclosure outside the reflectors to resolve this problem.

By the special designs, the light needed by the projector is emitted into the light tunnel. After other light is transmitted through the ellipsoidal and auxiliary reflectors and arrives in the enclosure, the unnecessary light is absorbed by the absorbent film on the enclosure to generate heat energy. The heat energy is quickly dissipated by the heat dissipation material of the enclosure to eliminate heat energy from the illumination system inside, and reduce the effects of overheating.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An illumination system for use in a projector, the illumination system comprising:
an ellipsoidal reflector, wherein a reflective film is coated on an inner surface of the ellipsoidal reflector, and the reflective film reflects necessary light and transmits a unnecessary light;
light source, configured at a first focus of the ellipsoidal reflector;
light tunnel, configured at a second focus of the ellipsoidal reflector; and
an auxiliary reflector, reflecting light emitted from the light source back to the light source, the auxiliary reflector having an opening therein, and the reflective film being coated on an inner surface of the auxiliary reflector.

2. The illumination system of claim 1, wherein a form and a dimension of the opening are determined by an angle and a power of the light emitted into the light tunnel.

3. The illumination system of claim 1, wherein a shape of the auxiliary reflector is a portion of a sphere.

4. The illumination system of claim 1, wherein a shape of the auxiliary reflector is a portion of an aspherical curve.

5. The illumination system of claim 1, wherein the opening is configured on an imagined straight line formed by the first focus and the second focus.

6. The illumination system of claim 1, wherein the light source is an arc lamp.

7. The illumination system of claim 1, wherein when the necessary light is visible light, and the unnecessary light is infrared and ultraviolet, a material of the reflective film comprises a cold mirror material.

8. An illumination system for use in a projector, the illumination system comprising:
an ellipsoidal reflector, wherein a reflective film is coated on an inner surface of the ellipsoidal reflector, and the reflective film reflects necessary light and transmits unnecessary light;
a light source, configured at a first focus of the ellipsoidal reflector;
a light tunnel, configured at a second focus of the ellipsoidal reflector;
an auxiliary reflector, reflecting light emitted from the light source back to the light source, the auxiliary reflector having a first opening, and the reflective film being coated on an inner surface of the auxiliary reflector; and
an enclosure, configured outside the ellipsoidal reflector and the auxiliary reflector, the enclosure having a second opening, an absorbent film being coated on an inner surface of the enclosure, and the absorbent film absorbing the unnecessary light.

9. The illumination system of claim 8, wherein forms and dimensions of the first opening and the second opening are determined by an angle and a power of the light emitted into the light tunnel.

10. The illumination system of claim 8, wherein the ellipsoidal reflector and the auxiliary reflector transmit the unnecessary light.

11. The illumination system of claim 8, wherein a shape of the auxiliary reflector is a portion of a sphere.

12. The illumination system of claim 8, wherein a shape of the auxiliary reflector is a portion of an aspherical curve.

13. The illumination system of claim 8, wherein the first opening is configured on an imagined straight line formed by the first focus and the second focus.

14. The illumination system of claim 8, wherein the second opening is configured on an imagined straight line formed by the first focus and the second focus.

15. The illumination system of claim 8, wherein the light source is an arc lamp.

16. The illumination system of claim 8, wherein a material of the enclosure is a heat-dissipating material.

17. The illumination system of claim 8, wherein the heat-dissipating material is metal.

18. The illumination system of claim 8, wherein the when the necessary light is visible light, and the unnecessary light is infrared and ultraviolet, a material of the reflective film comprises a cold mirror material.

19. The illumination system of claim 18, wherein a material of the absorbent film comprises an infrared absorbing material.

20. The illumination system of claim 18, wherein a material of the absorbent film comprises an ultraviolet absorbing material.
